(19) United States
(12) Patent Application Publication
(10) Pub. No.: US 2010/0198486 A1
(43) Pub. Date: Aug. 5, 2010

(54) METHOD FOR OPERATING AN INTERNAL COMBUSTION ENGINE

(75) Inventors: Martin Streib, Vaihingen (DE); Georg Mallebrein, Korntal-Muenchingen (DE); Federico Buganza, Nonantola (Mo) (IT); Kai Jakobs, Filderstadt (DE); Juergen Pfeiffer, Pforzheim (DE); Emilie Hincker-Piocelle, Ludwigsburg (DE); Pierre-Yves Crepin, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/598,725

(22) PCT Filed: Mar. 20, 2008
(86) PCT No.: PCT/EP2008/053361

§ 371 Date: Apr. 19, 2010

(30) Foreign Application Priority Data
May 4, 2007 (DE) 10 2007 020 960.8

(51) Int. Cl. F02D 41/30; F02B 13/00

(52) U.S. Cl. 701/104; 123/575

(57) ABSTRACT

The invention relates to a method for operating an internal combustion engine, which can be operated with fuels and fuel mixtures of said fuels, said fuels differing from each other in the air quantity they require for a stoichiometric combustion. A fuel quantity to be supplied to the internal combustion engine is corrected via a mixture adaptation and a fuel adaptation, the mixture adaptation and the fuel adaptation being based on a lambda control and a fuel quantity contained in the fuel reservoir of the internal combustion engine prior to refueling and a fuel quantity supplied to the reservoir being determined. The method is characterized by using the change of the fuel adaptation after refueling towards a fuel/air mixture having a higher or a lower fuel percentage to extrapolate the supplied fuel or the supplied fuel mixture and the fuel quantity present in the reservoir and the knowledge of the nature of the fuel or the fuel mixture supplied to the reservoir are used to calculate the fuel mixture ration in the reservoir after refueling. The method according to the invention allows determination of the fuel mixture ratio in the reservoir of internal combustion engines which can be operated with different fuels.

### STATE OF THE ART

The invention concerns a method for operating a combustion engine, which can be operated with fuels and fuel mixtures of said fuels, which differ from each other by the air quantity they require for a stoichiometric combustion, whereby a fuel amount that has to be supplied to the combustion engine is corrected by a mixture adaptation and a fuel adaptation, whereby the mixture adaptation and the fuel adaptation take place on the basis of a lambda regulation and whereby a fuel quantity that is present in a tank that contains the fuel reservoir of the combustion engine and a fuel quantity that is supplied to the tank are determined before a refueling.

DE 30 36 107 C3 describes a regulation unit for a fuel metering system at a combustion engine consisting of a fuel supply device (fuel injection vale), a lambda probe, measures (timer) for creating a basic metering signal, which is corrected depending on operating parameters and finally determines the control signal (ti) of the fuel supply device, a lambda regulator, which determines a correction factor based on a signal (λ) that has been measured by the lambda probe, which multiplicatively influences the basic metering signal (tp) with the correction factor. Thereby it is provided that the lambda correction depends not only on the correction factor (KR λ) by also on an additive (KA λ) and/or a multiplicative (KL λ) correction parameter, which is determined depending on the correction factor and the operating parameters.

The regulation unit enables thereby to balance systematic deviations of the fuel metering that is preset by the basic metering signal, thus the so-called pre-controlling, from the value that has been determined by the lambda regulation by an adaptation interference with a corresponding long-term correction. Systematic deviations can for example be caused by ageing influences or by manufacturing influences. In average the quantity of fuel that has been defined by the corrected pre-control is equivalent to the actually required quantity. Short-term deviations can be balanced by the lambda regulator, which is now again provided with the entire regulating area. The present method is also known under the term mixture adaptation.

DE 41 17 440 C2 describes a method for an adaptive adjusting of a fuel/air mixture for considering fuel features in the operation of the combustion engine, which provides a lambda regulator, which emits a regulating factor RF, and which provides an adaptation integrator, which emits an adaptation factor AF with a variable adaptation speed, which influences not only the regulating factor RF but also the adjustment of the fuel/air mixture. It is thereby provided that it is checked whether the lambda regulation deviation amplitude exceed a first threshold value, and, if that is the case, the adaptation speed is set to a higher value so long until a default condition is fulfilled, after which a low adaptation speed is set again.

The procedure enables an undisturbed operation of operate combustion engines, which can be operated with different fuels. Thus the injection time has for example be increased by more than 40% at a change from a fuel benzene to a fuel mixture consisting of 85% ethanol and 15% benzene in order to get the same lambda values in the exhaust gas. This is justified by the different air demand for a stoichiometric combustion, which is located for benzene at a ratio of 14.7:1 and at a nowadays common mixture of 85% ethanol and 15% benzene (term E85) at 9.0:1. According to the method that is described in DE 41 17 440 C2 a corresponding adaptation intervention is therefore carried out. Because a correction of the injection times and therefore of the adaptation intervention has to be carried out at a fuel change that is very strong compared to ageing influences or manufacturing influences the adaptation speed is significantly increased at a determined fuel change at the suggested method.

The disadvantage of the described method is that multiplicative errors, thus error, which have the same effect on the entire load—engine speed area, cannot be distinguished at first in a stationary operation of a warm combustion engine from mixture deviations due to a changed fuel mixture ratio and therefore a changed stoichiometric factor of the fuel mixture. It is therefore possible that the fuel adaptation interprets mixture errors as a change of the mixture ratio and adapts correspondingly. In a particular temporary mixture error, but systematically present during the fuel adaptation causes a consideration at the fuel adaptation.

Contrariwise a not adapted change of the fuel mixture ratio can be considered as mixture error at a mixture adaptation, for example if a refueling has not been detected.

This error interpretation has at first no negative effect on the lambda adjustment of the warm combustion engine in stationary operation, because the stoichiometric correction is correct in total. But the exact knowledge of the fuel mixture ratio is necessary at a different point, in order to be able to make assumption about further fuel features. Thus the exact fuel mixture ratio is for example necessary for the ignition angle calculation for optimizing the efficiency of the combustion engine.

It is the task of the invention to provide a method, which enables the determination of the fuel mixture ratio at combustion engines, which can be operated with different fuels or fuel mixtures.

### DISCLOSURE OF THE INVENTION

Advantages of the Invention

The task is thereby solved, that due to the change of the fuel adaptation after a refueling towards a fuel/air mixture with a higher or a lower fuel percentage the supplied fuel or the supplied fuel mixture can be assumed, and that from the fuel quantity that has been present in the tank before refueling, the fuel mixture ratio that has been present before the refueling in the tank, the fuel quantity that has been supplied to the tank and the knowledge of the fuel or fuel mixture that has been supplied to the tank the fuel mixture ratio in the tank after refueling is calculated.

If the combustion engine is for example operated with benzene or a fuel mixture of benzene and ethanol with maximally 85 volume percent ethanol (E85), the stoichiometric ratio of the air/fuel mixture that is supplied to the combustion engine can change from 14.7:1 for pure benzene up to 9.0:1 for E85. If for example pure benzene is fueled to an existing fuel mixture of benzene and ethanol in a fuel tank of the combustion engine the fuel adaptation will cause a reduction of the fuel quantity that is supplied to the combustion engine. Also at the addition of a fuel mixture, which has a higher ethanol content than the fuel mixture that is present in the tank, the fuel adaptation causes a higher fuel quantity that is metered into the combustion engine. On the basis of the course of the fuel adaptation a fueled fuel mixture can be therefore assumed. The relative change of the metered fuel quantity or a parameter that is referring to it can thereby be considered to a value before refueling or the relative change of the metered fuel quantity or a parameter that is referring to it can be considered referring to a known, for a default fuel composition applicable value, for example pure benzene. With the thus obtained knowledge of the fueled fuel type, the known quantity of the fueled fuel as well as the fuel composition and fuel quantity in the fuel tank before refueling the mixture ration in the fuel tank after refueling can be calculated. The accuracy of the calculation of the mixture ratio depends thereby amongst others on the fact how exact the fuel composition of the fueled fuel can be circumscribed.

An exact determination of the adjusting mixture ratio in the tank of the combustion engine can be thereby achieved that two possible mixture ratios of the supplied fuel consisting of two fuels are assumed, that an assignment of the supplied fuel to one of the possible mixture ratios is carried out by the change of the fuel adaptation after refueling towards a fuel-air mixture with a higher or a lower fuel percentage and that the calculation of the fuel mixture ratio in the tank is carried out for this specific fuel.

In many countries fuels are only offered in two mixture ratios. Thus it can for example be assumed at a refueling that either pure benzene or an ethanol-benzene-mixture has been refueled in a default mixture ratio. By the change direction of the fuel adaptation it can be clearly determined which of the two possible fuels has been fueled. When knowing the supplied fuel quantity, of the fuel quantity that has been present in the fuel tank before refueling and its mixture ratio the mixture ratio that results after refueling can be calculated very accurately.

If the fuel mixture ratio in the fuel tank is calculated it can be provided according to a preferred measure of the invention that the fuel adaptation that is carried out on the basis of the lambda regulation is corrected with the aid of the calculated fuel mixture ratio.

According to a further advantageous embodiment of the invention it can be provided that during the correction of the fuel adaptation a revered correction of the mixture adaptation is carried out in such a way that the air/fuel mixture that has been present before the correction of the fuel adaptation is the same. This air/fuel ratio is adjusted correctly before the correction of the fuel adaptation by the mixture adaptation and the fuel adaptation. Only the specific contribution of the mixture adaptation and the fuel adaptation to the total adaptation is possibly incorrect. The described method ensured therefore that the correct air/fuel ratio is preserved.

According to a further embodiment of the invention it can be provided that for the supplied fuel random mixture ratios of two fuels are assumed in at least default limits, that a maximally possible change of the fuel mixture ratio in the tank is determined by the supplied fuel and that a reasonability check of the fuel adaptation that is carried out on the basis of the lambda regulation is carried out on the basis of the possible fuel mixture ratios in the fuel tank. If the fuel mixture ratio that has been determined by the fuel adaptation lies outside a calculated band of possible fuel mixture ratio an error of the carried out fuel adaptation can be assumed. This can for example be a too late shifting to a fuel adaptation or the occurrence of an error in the system during the fuel adaptation.

As an alternative to the described methods to determine the fuel mixture ratio in the tank of a combustion engine, nowadays fuel type sensors are already used. The correct function of such a fuel type sensor can thereby be controlled that the calculated fuel mixture ratio is compared to a fuel mixture ratio that has been determined by a fuel type sensor and that an error function is assumed, if the difference between the determined fuel mixture ratio exceeds a default threshold value and/or that the fuel mixture ratio that has been determined by the fuel adaptation on the basis of the lambda regulation is compared to the fuel mixture ratio that has been determined by the fuel type senor and that an error function is assumed if the difference between the determined fuel mixture ratios exceeds a default threshold value.

The described method can preferably be used at a combustion engine that can be operated with benzene or a mixture of benzene and ethanol, preferably a mixture of benzene and maximally 85% ethanol.

### SHORT DESCRIPTION OF THE DRAWING

The invention is further explained in the following with the aid of the embodiment that is shown in the figure.

FIG. 1 shows in a block diagram the calculation of corrected fuel—and mixture adaptation values.

### EMBODIMENTS OF THE INVENTION

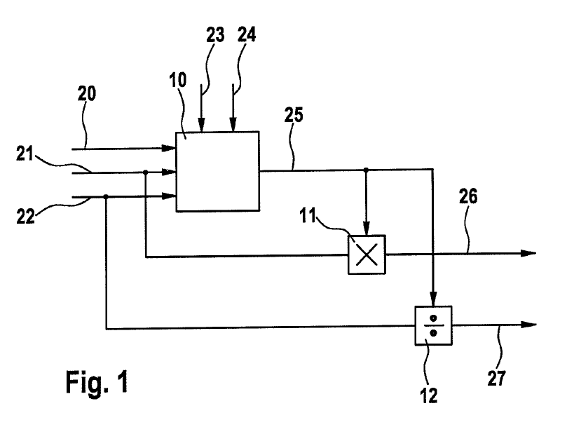

FIG. 1 shows in a block diagram the calculation of a fuel adaptation value after a correction f_k_korr 26 and a mixture adaptation value after a correction f_g_korr 27 as a possible application of the determination of the fuel mixture ratio in a fuel tank of a not shown combustion engine after refueling according to the invention.

A calculation unit 10 is provided with the signals relative refueling rel_b 20, fuel adaptation value before correction f_k_21 and mixture adaptation value before correction f_g 22.

Furthermore the calculation unit 10 is provided with the information about the stoichiometric factor fuel 1 S_{—}1 23 and the stoichiometric factor fuel 2 S_{—}2 24.

The fuel adaptation value before correction f_k 21 is additionally delivered to a multiplication point 11, while the mixture adaptation value f_g 22 is delivered to a division point 12. Multiplication point 11 and division point 12 preserve furthermore as input signal a correcting factor 25 as a starting signal of the calculation unit 10. In the multiplication point 11 a fuel adaptation value after correction f_k_korr 26 is created, in the division point 12 a mixture adaptation value after correction f_g_korr 27.

It is assumed in the illustrated embodiment that only two specific fuel mixtures are offered at gas stations. Thereby fuel 1 is pure benzene and fuel 2 a mixture of ethanol and benzene in a mixture ratio of approximately 85:15 volume percent. This mixture is called in the following E85.

Benzene and E85 differ significantly from each other by the air quantity they require for a stoichiometric combustion. The stoichiometric ratio for benzene is thereby located at 14.7:1, while it is located for E85 at 9.0:1. Therefore an increased metered quantity of fuel is required at E85 also in stationary operation of a combustion engine. The different stoichiometric factors are delivered to the calculation unit 10 in the form of the stoichiometric factor fuel S_{—}1 23 for pure benzene and the stoichiometric factor fuel S_{—}2 24 for E85.

The adjustment of the fuel quantity that is supplied to the combustion engine takes place according to familiar procedures by a so-called fuel adaptation. The fuel adaptation determined the fuel adaptation value before correction f_k 21, with which the fuel quantity that has been supplied to the combustion engine after a fuel change is corrected on the one hand and which is delivered in the illustrated embodiment to the calculation unit 10 on the other hand.

Also according to familiar procedures mixture errors are balanced by a so-called mixture adaptation. This mixture adaptation creates the mixture adaptation value before correction f_g 22. With this value the fuel quantity that is supplied to the combustion engine is corrected and it is furthermore delivered to the calculation unit 10.

The relative refueling rel_b 20 that has been delivered to the calculation unit 20 describes how much fuel V_b has been fueled during refueling referring to the fuel quantity that has been in the fuel tank before refueling. The fuel quantity that has been in the fuel tank before refueling is composed of a volume fuel 1 V_{—}1 and a volume fuel 2 V_{—}2. The added fuel quantity V_b is for example determined by a refueling detection.

If fuel 1, thus pure benzene is added to a random fuel mixture in the tank of the combustion engine, the fuel adaption value before correction f_k 21 will change in so far that the fuel quantity that is supplied to the combustion engine is reduced, thus that a lean air/fuel mixture adjusts as long as the tank content has not also been pure benzene before refueling. Correspondingly the fuel adaptation value before correction f_k 21 will change into a rich air/fuel mixture if fuel, thus E85 has been added. With the aid of the change of the fuel adaptation value before correction f_k 21 the calculation unit 10 can also clearly decide which of the two fuel types has been added.

If the mixture ratio in the tank before refueling mv_vor is known and stored in the calculation unit 10, the calculation unit 10 can calculate the mixture ratio in the tank after refueling mv_nach:

mv_nach=(V_{—}2+mv_{—}b*V_{—}b)/(V_{—}1+V_{—}2+V_{—}b)

mv_nach=(mv_vor+mv_{—}b*relb)/(1+rel_b)

Thereby the two possible mixture ratios of the supplied fuel mv_b are stored in the calculation unit 10 and selected on the basis of the change of the fuel adaptation.

From the mixture ration in the tank after refueling mv_nach, the known stoichiometric factors fuel 1 S_{—}1 23 and fuel 2 S_{—}2 24 as well as fuel densities rho_{—}1 for fuel 1 and rho_{—}2 for fuel 2 that are also stored in the calculation unit 10 the calculation unit 10 can calculate a fuel adaptation value f_k_nach as multiplicative volume correction.

f_{—}k_nach=(S_{—}1*rho_{—}2)/(S_{—}1*rho_{—}2*(1-mv_nach)+S_{—}2*rho_{—}1*mv_nach)

f_k_nach=1/(mv_nach*(S_{—}2/S_{—}1*rho_{—}1/rho_{—}2-1)+1)

Considering further conditions, for example the accuracy or the relative refueling, the fuel adaptation value f_k that is adjusting from the fuel adaptation can be approximated to f_k_nach according to different strategies.

In the embodiment that is shown in FIG. 1 the calculation unit 10 provides therefore a correcting factor 25, which multiplicatively connects at the multiplication point 11 with the fuel adaptation value before correction f_k_21 and thus creates the fuel adaptation value after correction f_k_korr according to the fuel adaptation value f_k_nach.

In order to preserve the correct air/fuel mixture that has been created before the correction of the fuel adaptation the mixture adaptation is corrected reversely to the fuel adaptation. Therefore the mixture adaptation value before correction f_g 22 is converted into the mixture adaptation value after correction f_g_korr with the aid of the correcting factor 25 in the division point 12.

1. A method for operating an internal combustion engine, that is operated with fuels and fuel mixtures of said fuels, wherein said fuels differ in a quantity of air required for a stoichiometric combustion, and wherein a fuel quantity to be supplied to the internal combustion engine for combustion is corrected by a mixture adaptation and a fuel adaptation, that are each controlled by a lambda control, the method comprising:
determining a fuel quantity in a fuel tank prior to refueling
determining a fuel or fuel mixture quantity supplied to the fuel tank during fueling; and
calculating a fuel mixture ration of the fuel in the tank after refueling by using the fuel quantity in the fuel tank prior to refueling and a knowledge of the nature of the fuel or the fuel mixture supplied to the tank during fueling, wherein the nature of the supplied fuel or fuel mixture is assumed due to the change of the fuel adaptation after refueling towards a fuel/air mixture having a higher or a lower fuel percentage.

2. The method according to claim 1 further comprising, based on two possible mixture ratios of the supplied fuel of two fuels, performing an assignment of the supplied fuel to one of the possible mixture ratios with the aid of the change of the fuel adaptation after a refueling towards a fuel/air mixture having a higher or a lower fuel percentage, wherein the calculation of the fuel mixture ratio is carried out in for this specific fuel.

3. The method according to claim 1, further comprising correcting the fuel adaptation that is carried out on the basis of the lambda control with the aid of the calculated fuel mixture ratio.

4. The method according to claim 3 further comprising performing a reversed correction of the the mixture adaptation during the correction of the fuel adaptation such that an air/fuel ratio that has been adjusted before the correction of the fuel adaptation stays the same.

5. The method according to claim 1, further comprising:
assuming that random mixture ratios of two fuels are within default limits for the supplied fuel;
determining a maximum possible change of the fuel mixture ratio in the tank by the supplied fuel; and
performing a reasonability check of the fuel adaptation on the basis of the lambda control based on the a possible fuel mixture ratio in the tank.

6. The method according to claim 1, further comprising performing at least one of:
comparing the calculated fuel mixture ratio to a fuel mixture ratio that has been determined by a fuel type sensor, wherein an error function is assumed if a difference between the compared fuel mixture ratios exceeds a default threshold value; and
comparing a fuel mixture ratio that has been determined by the fuel adaptation on the basis of the lambda control to the fuel mixture ratio that has been determined by the fuel type sensor wherein an error function is assumed if the difference between the determined fuel mixture ratios exceeds a default threshold value.

7. The method according to claim 1, further comprising an internal combustion engine with benzene or a mixture of benzene and ethanol, preferably with a mixture of benzene and maximally 85% ethanol.
